(19) United States
(12) Patent Application Publication
(10) Pub. No.: US 2005/0150721 A1
(43) Pub. Date: Jul. 14, 2005

(54) Working device for inner wall surface of tower tank, and inner wall surface working method using the same

(75) Inventors: Reiki Fujiwara, Ehime (JP); Masaaki Ito, Ehime (JP)

Correspondence Address: JORDAN AND HAMBURG LLP, 122 EAST 42ND STREET, SUITE 4000, NEW YORK, NY, 10168, US

(73) Assignee: Daio Paper Corporation, Shikokuchouo-shi (JP)

(21) Appl. No.: 10/502,719

(22) PCT Filed: May 8, 2003
(86) PCT No.: PCT/JP03/05793

(30) Foreign Application Priority Data
May 10, 2002 (JP) 2002-136312

(51) Int. Cl. A62B 1/20

(52) U.S. Cl. 182/48

(57) ABSTRACT

By using a construction in which a suspended beam structure (9) is suspended from a suspension support base (8) that has been installed inside a tower structure (1), in a manner that enables movement up and down of the suspended beam structure, an operations unit (20) is attached to the suspended beam structure (9) via a guide mechanism (Z), in a manner that enables movement up and down, and/or left and right, and operations such as welding are then performed on an inner wall surface (1d) of the tower structure (1) using the operations unit (20), the operating height position for the operations unit (20) is easily altered by moving the suspended beam structure (9) up or down, the operation for adjusting levels during operations is markedly simplified, or even unnecessary, and the safety and operating efficiency of operations is improved.

### TECHNICAL FIELD

The present invention relates to an operations apparatus for performing a variety of operations on an inner wall surface of a tower structure, and an operational method that uses such an operations apparatus. In particular, the invention relates to an operations apparatus and an operations method for performing welding operations on the inner wall surface of a tall tower structure used under conditions of high pressure and high temperature.

### BACKGROUND ART

Many methods have been proposed for performing the various operations on the inner wall surface of a tower structure, including putting up a scaffold within the inside of the tower structure, but no operations apparatus or operational method has yet appeared that could be said to be satisfactory in terms of operating efficiency, operating time, and safety.

Operations on the inner wall surface of a tower structure include welding, inspections, modifications, and cleaning, and welding operations have been the most needful of improvements in terms of continuity of the operation, danger, and the welding system.

For example, in a paper production plant, the digester, which is the pressure vessel with a blast furnace type construction that is used in pulp dissolution, is used under conditions of high temperature and high pressure, and in the type of environment that accompanies the chemical reaction between the contents and the chemicals used, and consequently, is specified in the safety standards as a type 1 pressure vessel.

In this type of tower structure, prolonged use of the tower requires that inspections, cleaning, welding, and modification operations are performed frequently. Particularly in the digester, which is a pressurized vessel, prolonged use raises concerns about the development of secular cracking defects such as stress corrosion cracking. This type of stress corrosion cracking develops due to the combined action of a number of factors including deterioration factors such as localized changes in the material (typically steel plate) that forms the inner wall surface of the digester, stress factors such as tensile residual stress arising from the heat generated during welding, and corrosion environment factors resulting from either high temperatures and high pressure or from chemical reactions, and moreover the cracks gradually grow over time. As a result, there is a danger that cracks caused by this stress corrosion cracking may penetrate right through the wall of the digester, in some cases causing a major accident within the plant. Furthermore, in addition to crack type defects such as the stress corrosion cracking described above, it is also common knowledge that during prolonged use of the digester, the contents (such as pulp material and the like) continually grind against the inner wall surface of the digester under a high temperature, high pressure environment, gradually wearing away the inner walls and reducing their thickness.

Because of these circumstances, digesters must be maintained at the safety standard for a type 1 pressure vessel, and the thickness of the wall sections must not only meet a design thickness deemed necessary to ensure a strong design, but must also include an additional level of excess thickness to ensure a predetermined safety factor.

However, even if a predetermined level of excess thickness is added to the thickness of the wall sections in this manner, prolonged use still results in the unavoidable development of crack type defects and a reduction in wall thickness arising from abrasion, and accordingly, the interior of the digester is inspected regularly for corrosion and wear and the like after a predetermined period of operation, and the requited repair operations are carried out where necessary. For example, in the case of a crack type defect, possible actions include overlay repair methods in which the defective section is removed, and overlaying is used to recover the thickness to its original value, and lining methods in which the area incorporating the crack type defective section is covered with a repair plate, which is then welded in place to isolate the crack type defective section from the corrosive environment and prevent any further growth of the crack. Furthermore, for abrasion based thinning of the walls, one possible measure is an “overlay method” in which overlay welding is performed within those sections of reduced thickness to recover the thickness to its original value. An “overlay method” is a technique that is particularly effective for repairing any of the above problems, and is gaining attention as an ideal technique for prolonging the life of tower structures such as digesters.

However, in cases where this “overlay method” is employed as a method for countering the shortening of the life of a tower structure such as a digester resulting from thinning of the walls, the following types of problems arise.

Namely, in cases where repair of the wall surfaces of a tower structure is undertaken via this “overlay method”, the reduced thickness sections of the inner surfaces (that is, the targeted regions for repair) must be entirely covered with as uniform a cladding as possible, and consequently operational control of factors such as the width of the weld bead and the spacing between adjacent weld beads is essential.

In such cases, and particularly in cases in which the tower structure being worked upon is a large scale, very high structure such as a digester, entrusting this operational control entirely to the actions and judgment of an operator has limits in terms of ensuring an adequate level of control precision and achieving an effective extension of the life of the digester through overlay welding, and some form of automated technique is required.

Accordingly, an object of the present invention is to provide an operations apparatus for the inner wall surface of a tower structure that enables various operations performed on the inner wall surface of the tower structure to be conducted in a safer operating environment, with good operability and good reliability, as well as an operational method that utilizes such an operations apparatus.

### DISCLOSURE OF THE INVENTION

In order to achieve the above object, in a first aspect of the present invention, a suspension support base is installed inside a tower structure, a suspended beam structure is suspended from the suspension support base in a manner that enables movement up and down, a welding unit is attached to the suspended beam structure via a guide mechanism in a manner that enables movement up and down, and/or left and right, and operations are performed on the inner wall surface of the tower structure using the operations unit.

According to an operations apparatus for the inner wall surface of a tower structure according to the first aspect of the present invention described above, by moving the suspended beam structure suspended below the suspension support base in an upward or downward direction, the height position within the tower structure of the operations unit attached to the suspended beam structure, in other words, the height setting within the tower structure for the operational target region for the operations unit, can be easily altered, and compared with a conventional case where a scaffold is put up inside the tower structure, and the height of the scaffold has to be changed every time the operating height is altered, the operation for adjusting levels during operations is markedly easier, or even unnecessary, which provides an equivalent improvement in the safety and operability associated with all manner of operations.

In addition, because the operations unit is attached to the suspended beam structure via the aforementioned guide mechanism, allowing the operations unit to be moved up and down, and/or left and right, control of the required operations performed using the operations unit (for example in the case of welding operations, control of the width of the weld bead, the weld direction, or the spacing between adjacent weld beads) is far easier and more reliable than the case in which this control depends solely upon the actions and judgment of the operator, and as a result, a very uniform operation will be conducted over an entire required height region with excellent reliability, thereby ensuring an effective extension of the life of the tower structure.

Furthermore, a second aspect of the present invention is the operations apparatus for the inner wall surface of a tower structure described above, wherein the aforementioned guide mechanism comprises an upper guide structure and a lower guide structure that are separated and oppose each other across the vertical direction, and a vertical guide structure, which extends between each of the guide structures and is disposed in the vertical direction, is able to move in a left and right direction along the upper and lower guide structures, and supports the aforementioned operations unit in a manner that enables up and down movement.

According to an operations apparatus for the inner wall surface of a tower structure according to the second aspect of the present invention, which has the type of structure described above, because the guide mechanism is a simple and low cost mechanism formed from the upper guide structure, the lower guide structure and the vertical guide structure, an inner wall surface operations apparatus that displays the effects of the first aspect of the present invention will be provided at lower cost, and this contributes to a reduction in operating costs.

In addition, a third aspect of the present invention is the operations apparatus for the inner wall surface of a tower structure described above, wherein the aforementioned operations unit is equipped with at least welding, inspection, modification, and cleaning functions.

According to an operations apparatus for the inner wall surface of a tower structure according to the third aspect of the present invention, the following characteristic effects will be achieved in addition to the effects provided by the first or second aspects of the invention. Namely, in this aspect of the invention, because the operations unit is equipped with at least welding, inspection, modification, and cleaning functions, these various operations on the inner wall surface of the tower structure can be performed conjointly, and all of the operations will be performed highly efficiently with a high level of reliability.

In addition, a fourth aspect of the present invention is the operations apparatus for the inner wall surface of a tower structure described above, wherein a post is set up in a vertical direction inside the tower structure, and a height adjustable operations platform is installed that can be raised and lowered under its own power in the vertical direction along this post.

According to an operations apparatus for the inner wall surface of a tower structure according to the fourth aspect of the present invention, the following characteristic effects will be achieved in addition to the aforementioned effects provided by the first, second or third aspect of the invention. Namely, in this aspect of the invention, because a post is set up in the vertical direction inside the tower structure, and a height adjustable operations platform is installed that can be raised and lowered under its own power in the vertical direction along this post, by raising and lowering the height adjustable operations platform under its own power in the vertical direction along the post, the height adjustable operations platform can be used to move operating materials or operators safely and rapidly to the operating position for the operations unit, without requiring any scaffold height adjustments, even if the tower structure is a blast furnace type structure of considerable height. As a result, both operational speed and safety are achieved, which leads to a reduction in the overall operational costs associated with the inner wall surface operations apparatus.

Furthermore, a fifth aspect of the present invention is the operations apparatus for the inner wall surface of a tower structure described above, wherein a fixed operations platform is attached to the post, the fixed vertical position of the fixed operations platform relative to the post can be set and altered, and alteration of the fixed position of the fixed operations platform is performed by raising or lowering the height adjustable operations platform.

According to an operations apparatus for the inner wall surface of a tower structure according to the fifth aspect of the present invention, which has the type of structure described above, the following characteristic effects will be achieved in addition to the aforementioned effects provided by the fourth aspect of the invention. Namely, in this aspect of the invention, because the fixed vertical position, relative to the post, of the fixed operations platform attached to the post can be set and altered, by fixing the fixed operations platform at a height position corresponding with the operating position for the operations unit, an operator rides on the fixed operations platform, and easily and accurately conducts quality control of the operations performed by the operations unit, enabling operations to be conducted with even greater reliability.

In addition, because positional alteration of the fixed operations platform is performed by raising or lowering the height adjustable operations platform, the operation for altering the position of the fixed operations platform would be performed safely and rapidly, without requiring any related operations such as scaffold height adjustments and the like, enabling good operational safety and a reduction in operating costs.

Furthermore, an operational method for an inner wall surface according to a sixth aspect of the present invention comprises the steps of installing a suspension support base inside a tower structure, suspending a suspended beam structure from the suspension support base in a manner that enables movement up and down, attaching an operations unit to the suspended beam structure via a guide mechanism in a manner that enables movement up and down, and/or left and right, and performing operations on the inner wall surface of the tower structure using the operations unit.

According to the type of operational method for an inner wall surface according to the sixth aspect of the present invention, a suspension support base is installed inside a tower structure, a suspended beam structure is suspended from the suspension support base in a manner that enables movement up and down, an operations unit is attached to the suspended beam structure via a guide mechanism in a manner that enables movement up and down, and/or left and right, and operations are performed on the inner wall surface of the tower structure using the operations unit, and consequently, by moving the suspended beam structure suspended below the suspension support base in an upward or downward direction, the height position within the tower structure of the operations unit attached to the suspended beam structure, in other words, the height setting within the tower structure for the operational target region for the operations unit, would be easily altered, and compared with a conventional case where a scaffold is erected inside the tower structure, and the height of the scaffold has to be changed every time the operating height is altered, the operation for adjusting levels during operations is markedly easier, or even unnecessary, and this enables an improvement in the safety and operability associated with all manner of operations.

In addition, because the operations unit is able to move up and down, and/or left and right, control of the operating status of operations performed using the operations unit is extremely simple and reliable, and a very uniform operation will be conducted over an entire required height region with excellent reliability.

### BRIEF DESCRIPTION OF THE DRAWINGS

FIG. 1 is a cross-sectional view showing the operational state when an operations apparatus according to the present invention is used to perform an overlay welding operation on the inner wall surface of a digester.

FIG. 2 is an enlarged view along the arrow headed line II-II of FIG. 1.

FIG. 3 is an enlarged exploded perspective view showing the structure of the section III shown in FIG. 2.

FIG. 4 is an enlarged view along the arrow headed line IV-IV of FIG. 1.

FIG. 5 is an enlarged view along the arrow headed line V-V of FIG. 1.

FIG. 6 is an enlarged view along the arrow headed line VI-VI of FIG. 1.

FIG. 7 is an enlarged view along the arrow headed line VII-VII of FIG. 1.

FIG. 8 is an enlarged view of the section VIII shown in FIG. 1.

FIG. 9 is an enlarged view along the arrow headed line IX-IX of FIG. 8.

FIG. 10 is a view along the arrow headed line X-X of FIG. 9.

FIG. 11 is an enlarged view along the arrow headed line XI-XI of FIG. 1.

FIG. 12 is a view along the arrow headed line XII-XII of FIG. 11.

FIG. 13 is a diagram describing the state of weld beads.

FIG. 14 is a cross-sectional view along XIV-XIV of FIG. 13.

### BEST MODE FOR CARRYING OUT THE INVENTION

As follows is a description of an operations apparatus and an operational method according to the present invention, with reference to the drawings and using an apparatus for a welding operation, and the operational method therefor, as a representative example.

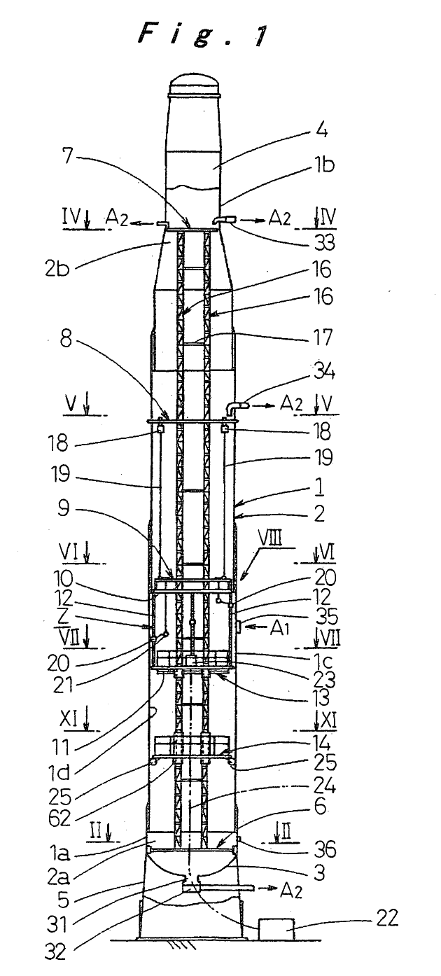

FIG. 1 shows a digester 1 (tower structure), which is the pressure vessel of a blast furnace structure used in a paper production plant, with an overlay welding operations apparatus (inner wall surface operations apparatus) for conducting overlay welding on required areas of the inner wall surface of the digester 1 disposed therein.

A: Configuration of the Digester 1

The digester 1 is, for example, a large scale, tall, closed vessel with an internal diameter of 4 to 5 meters and a height of 40 to 50 meters, and is classified as a type 1 pressure vessel in the safety standards. Accordingly, the thickness of the walls must be maintained above a defined constant thickness, and if the wall thickness is exposed to higher than expected abrasion, then in order to extend the life of the structure, a repair operation must be conducted to return the thickness to its original value, as described above. In this embodiment, an “overlay method” is adopted as the method of repairing the wall surfaces of the digester 1, which involves extra thickness being attached to the inner wall surface using overlay welding, and the overlay welding operations apparatus described above is used for executing this overlay welding.

The aforementioned digester 1 is formed as a sealed vessel, comprising a main body section 2 with a large diameter cylindrical structure, with a digester bottom structure 3 joined at one end and a digester top structure 4 joined at the other end, and is fixed in a vertical position with a bottom section 1a of the digester bottom structure 3 supported on a base 5. The main body section 2 is constructed so that the diameter dimension reduces in a stepwise manner from the bottom section 1a of the digester 1 through to a top section 1b, and a device such as a strainer (not shown in the drawing) is disposed in those regions where the diameter dimension reduces.

Furthermore in this embodiment, when overlay welding is performed on the inner wall surface of the digester 1 using the aforementioned overlay welding operations apparatus, in order to ensure good ventilation through the digester 1, manholes that are provided in the digester 1 for that purpose are used. In other words, an exhaust system 32 is attached to a bottom manhole 31 provided in a central position within the digester bottom structure 3, a large diameter manhole 35 provided substantially halfway up the digester is used as a natural air inlet, and additional exhaust systems 33, 34 are disposed at a pair of upper and lower manholes provided toward the top section 1b. During overlay welding operations, by supplying external air naturally through the manhole 35 to the inside of the digester 1, and then exhausting the air from each of the exhaust systems 32, 33, 34, air circulation is established within the digester 1, ensuring a good working environment inside the digester 1, and thereby guaranteeing a highly safe operation.

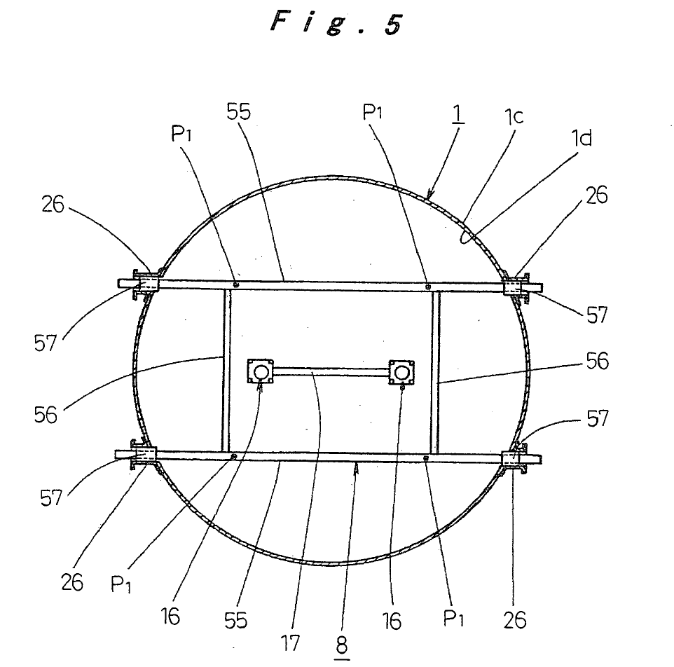

In addition, during overlay welding operations, a manhole 36 provided near the bottom section 1a of the digester 1 is used for introducing materials or allowing people to enter or exit from the digester 1, while a suspension support base 8, which is described below, is attached using four scaffold nozzles 26, 26, . . . (see FIG. 5) provided directly below the manhole equipped with the exhaust system 34.

In this embodiment, the execution of overlay welding using the overlay welding operations apparatus is described below for those sections of the inner wall surface of the digester 1 that are positioned below the attachment position of the suspension support base 8. Needless to say, by positioning the suspension support base 8 toward the top section 1b of the digester 1, overlay welding is performed along the entire height of the main body section 2.

B: Configuration of the Overlay Welding Operations Apparatus

As shown in FIG. 1, the aforementioned overlay welding operations apparatus comprises a left and right pair of posts 16, 16 (described below) disposed in a parallel upright manner with a predetermined spacing therebetween, which extend between a lower fixed operations floor 6 (described below) that is disposed near the bottom section 1a of the digester 1, and an upper fixed operations floor 7 (described below) that is disposed toward the top section 1b, and a height adjustable operations platform 14 (described below) that can be raised and lowered under its own power, and a fixed operations platform 13 (described below) are attached to each of the posts 16, 16, a suspended beam structure 9 (described below) is suspended from the aforementioned suspension support base 8 (described below) in a manner that enables movement up and down, and a plurality of welding units 20 (which correspond with the “operations unit” disclosed in the claims) are attached to the suspended beam structure 9 via a guide mechanism Z (described below) in a manner that enables free movement up and down, and/or left and right (in a circumferential direction) of each welding unit. As follows is a separate description of each of the structural elements of this overlay welding operations apparatus.

(B-1) Posts 16

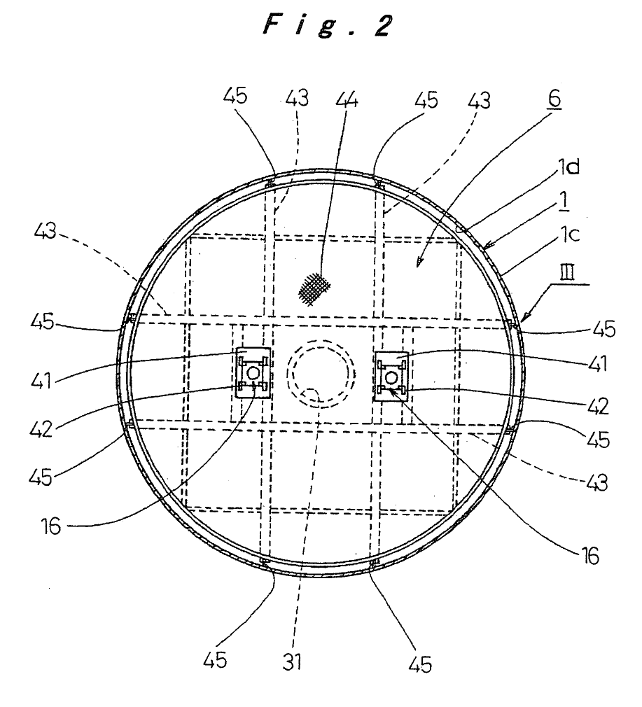

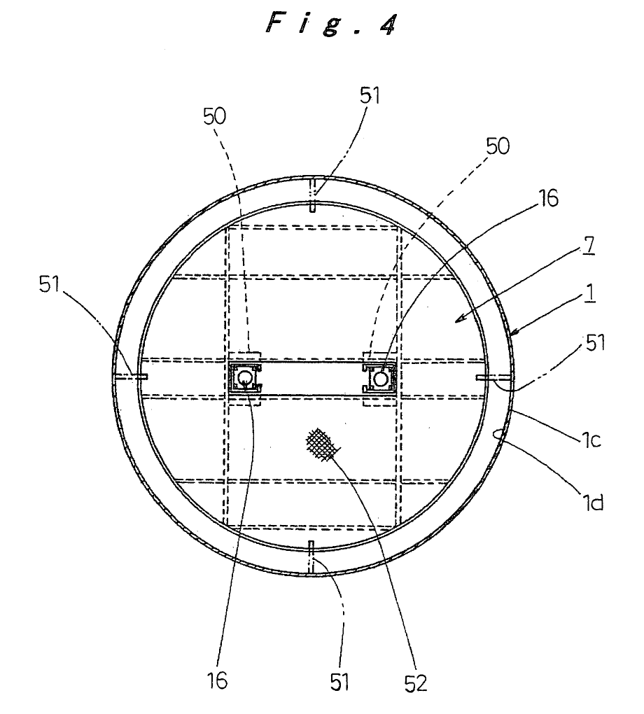

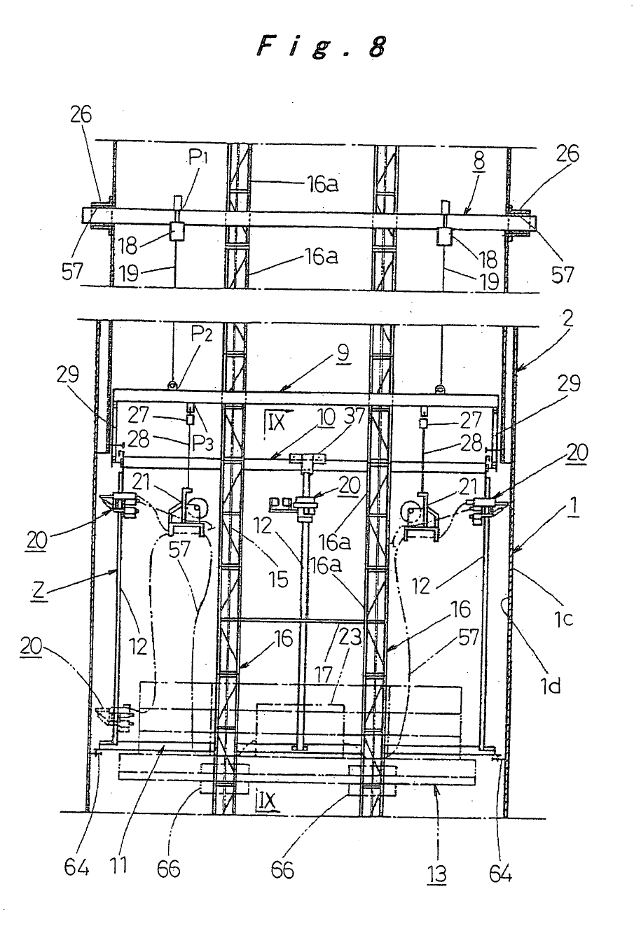

As shown in FIG. 1 and FIG. 8, the posts 16 are formed from truss structured post pieces 16a, 16a, . . . with a rectangular cross-section and a predetermined axial length, a predetermined number of which are joined together sequentially in an axial direction to form a column type structure. The posts 16, 16 are integrated together into an approximately ladder type structure by joint members 17, 17, . . . that are attached to the posts at predetermined intervals along the axial direction, and by fixing the bottom end of the ladder structure to the lower fixed operations floor 6 that is described below (see FIG. 2) and fixing the top end to the upper fixed operations floor 7 that is described below (see FIG. 4), the posts 16, 16 are secured in a vertical direction inside the digester 1.

In this embodiment, the aforementioned posts 16 utilized two parallel columns separated by a predetermined spacing, and as described below, a guiding action and a support function for the fixed operations platform 13 and the height adjustable operations platform 14 is achieved through interaction with these two posts 16, 16, but the actual number of posts 16 installed in the present invention can be suitably increased or decreased as required, and in other embodiments, either a single post, or three or more parallel posts can be provided.

The operational procedure used to set up a post 16 using the aforementioned post pieces 16a, 16a, . . . is as follows. Namely, first the bottommost pair of posts 16, 16 are secured in an upright orientation at predetermined positions on top of the aforementioned lower fixed operations floor 6. Subsequently, the height adjustable operations platform 14 that is described below is assembled to correspond with each of these bottommost posts 16, 16, and is produced so as to be able to be raised and lowered under its own power. An operator and the aforementioned post pieces 16a, 16a, . . . for joining to the posts are then loaded onto this height adjustable operations platform 14, and with the height adjustable operations platform 14 being raised and lowered along the already secured posts 16, 16, the operation of joining new posts 16 to the top end of the existing posts 16 is repeated until the aforementioned upper fixed operations floor 7 is reached. In other words, in this embodiment, the operation of setting up the posts 16 does not require the conventional type of prefabricated steel scaffold, and consequently, the operations associated with altering the height of the scaffold are unnecessary, which enables the operation of setting up the posts 16 to be completed safely and quickly.

A rack 15 that functions as one portion of the height adjustment mechanism of the height adjustable operations platform 14 is provided on one side of each the posts 16, 16, and runs along the lengthwise direction of each post 16, 16.

Furthermore, because the aforementioned post pieces 16a are carried into the digester 1 through the manhole 36, the post pieces must be set to a size and shape that enables passage through the manhole 36.

(B-2) Lower Fixed Operations Floor 6

As shown in FIG. 1, the lower fixed operations floor 6 described above is secured in an intermediate position between the position immediately above the digester bottom structure 3 of the digester 1, and the position immediately below the manhole 36, and is used as an “operations platform” as per its original function, but also performs the important function of acting as a support base for the posts 16, 16.

In other words, as shown in FIG. 2, the lower fixed operations floor 6 is constructed by attaching four support girders 43, 43, . . . in a cross girder arrangement, and then installing and fixing a flooring material 44 in a circular shape, the periphery of which extends out to a position close to, and facing the inner wall surface id of the side wall 1c, on top of these support girders 43, 43, . . . . Then, the posts 16, 16 are secured by mounting the bottom ends of the posts 16, 16 (that is, the bottom end of the post piece 16a positioned at the bottommost end of each post 16) onto a left and right pair of support bases 41, 41 provided toward the center of the lower fixed operations floor 6, restricting the movement of the posts via positioning stoppers 42, 42, . . . positioned at the outer periphery of the posts, and bolting the posts to the support bases via securing bolts (not shown in the drawing).

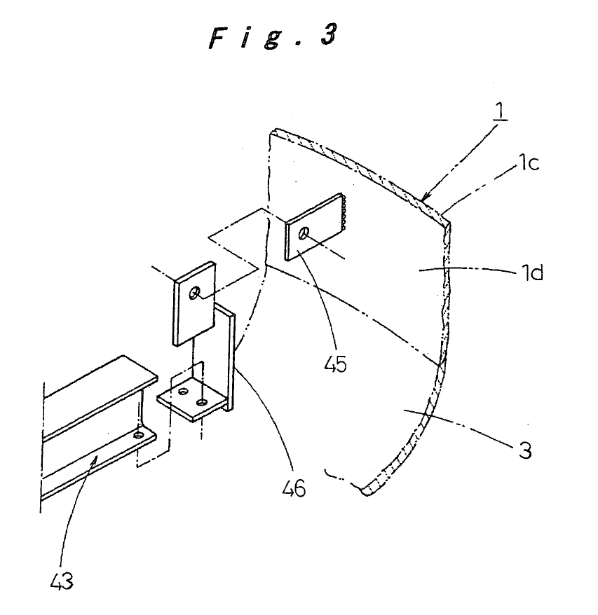

The most characteristic feature of the lower fixed operations floor 6 is the construction used to secure each of the support girders 43, 43, . . . to the digester 1. Namely, in this embodiment, as shown in FIG. 2 and FIG. 3, protruding securing pieces 45 are welded to the inner wall surface 1d of the side wall 1c at a position directly above the aforementioned digester bottom structure 3 of the digester 1, and each securing piece 45 and the end of a support girder 43 are secured together in a detachable manner via a connecting member 46. These securing pieces 45 are fixed around the periphery of the inner wall surface 1d with a predetermined spacing, so as to be positioned at each end of each of the four support girders 43, 43, . . . respectively. Then, when the overlay welding operations have been completed and the lower fixed operations floor 6 has been disassembled and removed, these securing pieces 45, 45, . . . remain attached to the digester 1, and the pulp digestion operation using the digester 1 is conducted with these securing pieces 45 still secured in place.

In this manner, the lower fixed operations floor 6 is attached to the bottom section 1a of the digester 1 via the securing pieces 45, 45, . . . , and by securing and supporting the posts 16, 16 on this lower fixed operations floor 6, the dead load of the posts 16, 16, the dead load of the fixed operations platform 13 and the height adjustable operations platform 14 described below, which are attached to the posts 16, 16, and the weight of the materials loaded onto each of these operations platforms 13, 14 are all transferred from the lower fixed operations floor 6, through the securing pieces 45, 45, . . . and onto the side walls 1c of the digester 1, where they are safely supported. As a result, absolutely no load from the posts 16, 16 is applied to the aforementioned digester bottom structure 3 positioned below the lower fixed operations floor 6, and any damage or the like to the digester bottom structure 3 will be effectively prevented. This effect is particularly important considering that the shape of the digester bottom structure 3 means that the production costs are higher than those of the cylindrically shaped main body section 2.

The aforementioned lower fixed operations floor 6 is the first structure set up when overlay welding operations are to be undertaken, and subsequent operations such as the transporting of various materials, and the assembling of the aforementioned posts 16, 16 or the height adjustable operations platform 14 are performed using this erected lower fixed operations floor 6 (in other words, it performs its primary function as an operations platform). Furthermore, because the lower fixed operations floor 6 is carried into and out of the digester 1 through the aforementioned manhole 36, each of the structural elements must be able to be disassembled down to a size capable of passing through the manhole 36 (not shown in the drawings).

(B-3) Upper Fixed Operations Floor 7

The upper fixed operations floor 7 described above is disposed at a position immediately below the digester top structure 4 of the digester 1 (see FIG. 1), has a circular, flat shape, and is positioned inside the side walls 1c of the digester 1 with a predetermined space retained between the floor and the side walls 1c. This upper fixed operations floor 7 is connected and secured to the top ends of the posts 16, 16 via a left and right pair of post securing members 50, 50 that are provided toward the center of the floor, while movement in the horizontal direction is regulated by bracing the tips of jacks 51, 51, . . . provided at four locations around the outer periphery of the floor against the inner wall surface id of the side walls 1c.

Because this upper fixed operations floor 7 is carried into and out of the digester 1 through the aforementioned manhole 36, each of the structural elements must be able to be disassembled down to a size capable of passing through the manhole 36 (not shown in the drawings).

(B-4) Suspension Support Base 8

The suspension support base 8 described above is disposed horizontally at a position toward the top section 1b of the digester 1, and supports the suspended guide mechanism Z described below, and as shown in FIG. 5 and FIG. 8, is constructed by inserting and engaging a girder member 55, via bearings 57, through a pair of scaffold nozzles 26, 26 formed in the side walls 1c of the digester 1 in opposing positions along an identical axis sitting to one side of the centerline of the digester, and through another pair of scaffold nozzles 26, 26 formed in opposing positions along an identical axis sitting to the other side of the centerline respectively, and then connecting this pair of girder members 55, 55 with joining members 56. The aforementioned posts 16, 16 pass vertically through the central section of this suspension support base 8, which is disposed horizontally across the inside of the digester 1.

Furthermore, suspension positions P₁, P₁, . . . are set at four positions near the connection points between each of the girder members 55, 55 and each of the joining members 56, 56 of the suspension support base 8. Then, as shown in FIG. 8, a chain block 18 is attached at each of these suspension positions P₁, P₁, . . . .

Because this suspension support base 8 is carried into and out of the digester 1 through the aforementioned manhole 36, each of the structural elements must be able to be disassembled down to a size capable of passing through the manhole 36 (not shown in the drawings).

(B-5) Suspended Beam Structure 9

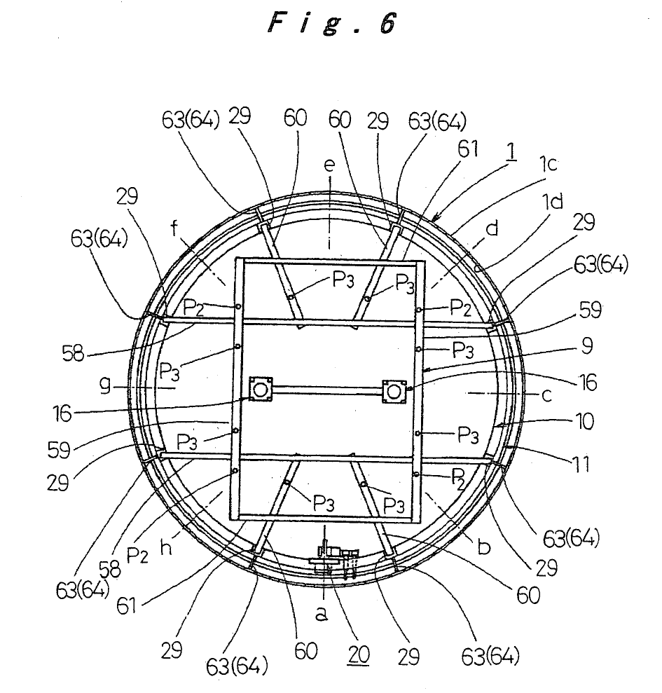

The suspended beam structure 9 described above is suspended from and supported by the aforementioned suspension support base 8, via each of the aforementioned chain blocks 18, 18, . . . , and supports the suspended guide mechanism Z described below, and as shown in FIG. 6 and FIG. 8, is constructed by attaching to the top of a pair of girder members 58, 58 disposed in parallel with a predetermined spacing therebetween, a pair of girder members 59, 59 that sit orthogonally relative to the girder members 58, 58, thereby forming a cross girder arrangement, and then attaching a pair of girder members 61, 61 that extend between the end sections at both ends of the pair of girder members 59, 59, and attaching pairs of girder members 60, 60 that extend from the girder member 58 across the corresponding girder member 61 in a radial direction.

Then, in this suspended beam structure 9, suspension positions P₂, P₂, . . . , each of which corresponds with one of the suspension positions P₁, P₁, . . . on the suspension support base 8, are set on top of the aforementioned pairs of girder members 59, 59, and the chains 19, 19, . . . hanging down from each of the chain blocks 18 positioned at the suspension support base 8 are connected to each of these suspension positions P₂, P₂, . . . , so that the suspended beam structure 9 is suspended from, and supported by the suspension support base 8 via these chains 19, 19, . . . , and can be raised or lowered vertically by winding each of the chains 19, 19, . . . in, or back out.

Furthermore, suspension positions P₃, P₃, . . . are set on the girder members 59, 59 containing the aforementioned suspension positions P₂ and on each of the girder members 60, 60, so as to be positioned on an identical circumference, with an identical pitch around the circumferential direction. Chain blocks 27, 27 are attached to each of these suspension positions P₃, P₃, . . . and a wire supply device 21 of a welding unit 20 described below is suspended via a chain 28 hanging down from each chain block 27, 27, . . . .

In addition, the end sections of the aforementioned pair of girder members 58, 58 of the suspended beam structure 9, and the end sections of each of the girder members 60, 60 are positioned on an identical circumference, with a predetermined pitch around the circumferential direction. These end sections function as the suspension and support points for the guide mechanism Z described below, and a suspension link 29 is attached to each end section.

Because this suspended beam structure 9 is carried into and out of the digester 1 through the aforementioned manhole 36, each of the structural elements must be able to be disassembled down to a size capable of passing through the manhole 36 (not shown in the drawings).

(B-6) Guide Mechanism Z

The guide mechanism Z described above guides the movement of the welding units 20 described below, enabling good overlay welding to be conducted by the welding units 20, and comprises an upper guide structure 10, a lower guide structure 11, and a vertical guide structure 12, each of which is described below.

(B-6-1) Upper Guide Structure 10

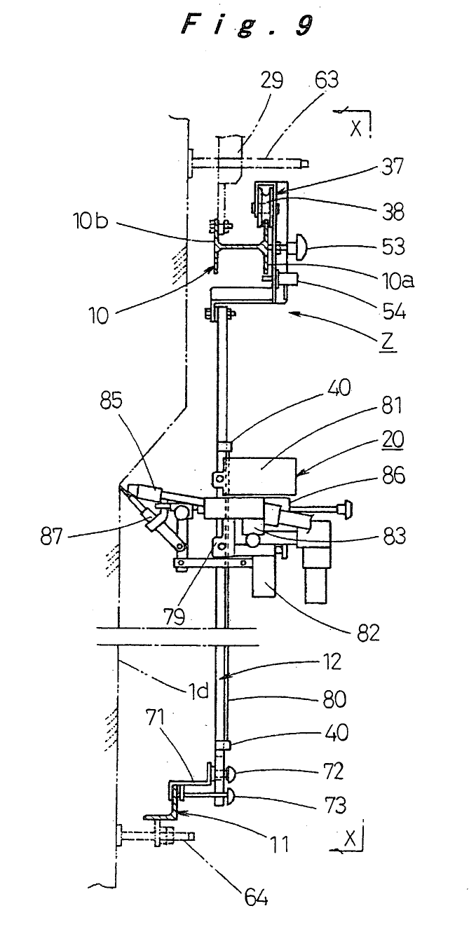

As shown in FIG. 6, and FIG. 8 through FIG. 10, the aforementioned upper guide structure 10 is constructed from an annular body (see FIG. 6) formed by curved molding of H-shaped steel (see FIG. 9), with the pair of flanges in a vertical arrangement, to enable the body to be positioned inside the inner wall surface 1d of the digester 1. This upper guide structure 10 is suspended from the suspended beam structure 9 via the aforementioned suspension links 29, 29, . . . , moves up and down in concert with the raising and lowering of the suspended beam structure 9, and as shown in FIG. 9, is supported against the inner wall surface id by bracing the tips of jacks 63, 63, . . . that are attached to each of the suspension links 29, 29, . . . against the inner wall surface 1d of the digester 1.

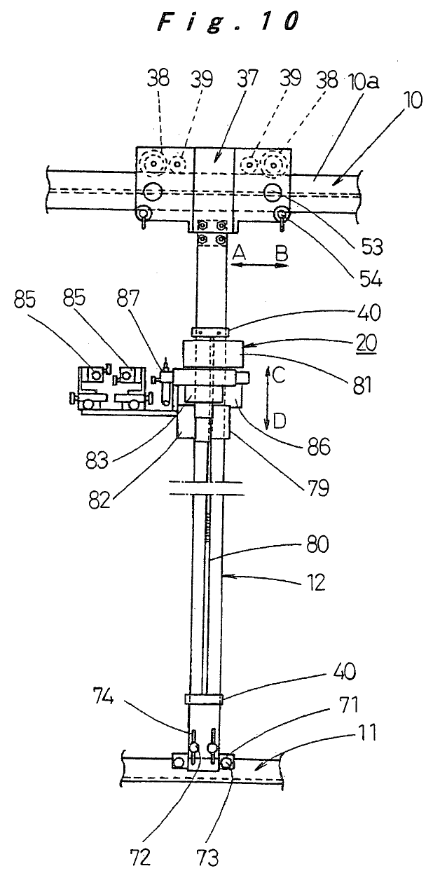

Furthermore, the upper guide structure 10 guides the movements of the vertical guide structure 12 described below in the left and right directions (that is, the circumferential direction of the inner wall surface 1d), and of the pair of flanges, the flange that is positioned on the inside in a radial direction is designed to function as a guide rail for the vertical guide structure 12, and consequently a saddle 37 for the vertical guide structure 12 is latched onto this inside flange (see FIG. 9 and FIG. 10).

Because the upper guide structure 10 is carried into and out of the digester 1 through the aforementioned manhole 36, each of the structural elements must be able to be disassembled down to a size capable of passing through the manhole 36 (not shown in the drawings).

(B-6-2) Lower Guide Structure 11

As shown in FIG. 6, and FIG. 8 through FIG. 10, the lower guide structure 11 described above is constructed from an annular body (see FIG. 6) formed by curved molding of L-shaped steel (see FIG. 9), with one of the flanges directed along the radial direction and the other flange directed upward, to enable the body to be positioned inside the inner wall surface 1d of the digester 1. This lower guide structure 11 is supported by the upper guide structure 10 via the vertical guide structure 12 that is described below, moves up and down when the upper guide structure 10 moves up and down in concert with the raising and lowering of the suspended beam structure 9, and as shown in FIG. 9, is supported against the inner wall surface 1d by bracing the tips of jacks 64, which are disposed with a predetermined spacing around the periphery of the lower guide structure 11, against the inner wall surface 1d of the digester 1.

As shown in FIG. 9 and FIG. 10, the connection between the aforementioned lower guide structure 11 and the vertical guide structure 12 described below is achieved by sandwiching one flange section of the lower guide structure 11 between a fixed bracket 71, which is supported by a check bolt 72 that is inserted through a slotted hole 74 formed in a vertical direction in the bottom end section of the vertical guide structure 12, and a push bolt 73 that is attached to the vertical guide structure 12. Furthermore, by loosening the push bolt 73, loosening the check bolt 72 and moving the fixed bracket 71 upward, the connection between the lower guide structure 11 and the vertical guide structure 12 are released.

(B-6-3) Vertical Guide Structure 12

As shown in FIG. 9 and FIG. 10, the vertical guide structure 12 is constructed from a batten plate structure of a predetermined length, one end (the top end) of which is attached to the saddle 37 described below. The vertical guide structure 12 guides the up and down movements of the welding units 20 described below, and by moving the vertical guide structure 12 in the left and right directions under the guidance of the upper guide structure 10 and the lower guide structure 11, the welding units 20 are also movable in the left and right direction.

The saddle 37 supports and suspends the vertical guide structure 12 from the upper guide structure 10, and enables the vertical guide structure 12 to be moved in the left and right directions along the upper guide structure 10, and as shown in FIG. 9 and FIG. 10, comprises a front and rear pair of slotted wheels 38, 38 that run along the top of the flange of the upper guide structure 10, and a front and rear pair of unslotted wheels 39, 39. In addition, the saddle 37 is also provided with a front and rear pair of check bolts 53, 53, which regulate the relative movement between the saddle 37 and the upper guide structure 10 by being screwed in until the tips of the bolts contact the upper guide structure 10, and a front and rear pair of lift prevention structures 54, 54, which are disposed so as to enable engagement against the bottom surface of the flange of the upper guide structure 10, and prevent the saddle 37 from lifting. The aforementioned vertical guide structure 12 is then secured so as to hang down from the saddle 37.

Furthermore, the aforementioned check bolt 72 and the push bolt 73 are provided at the bottom end of the vertical guide structure 12, and by operating this check bolt 72 and push bolt 73, the bottom end section of the vertical guide structure 12 is connectable to, and releasable from, the lower guide structure 11, as described above.

On the other hand, stoppers 40, 40 are provided at two vertical positions on the vertical guide structure 12, and a rack 80 is attached that extends between these two stoppers 40, 40. Then, a welding unit 20 that is described below is attached to the vertical guide structure 12, and can be raised and lowered along this rack 80.

A plurality of vertical guide structures 12 constructed in the manner described above are disposed at predetermined intervals around the circumference of the upper guide structure 10. In this embodiment, vertical guide structures 12 are disposed at eight positions, as shown by position a through position h in FIG. 6.

(B-7) Welding Unit 20

As shown in FIG. 9 and FIG. 10, the welding unit 20 described above comprises a carriage 79 that straddles the vertical guide structure 12 and is driven up and down along the rack 80 by the driving force from a motor 86, on which is mounted a welder main body 81, an oscillating device 82, a profiling device 83, a pair of welding torches 85, 85, and a profile detector 87. Furthermore, the welder main body 81 is a device that automatically performs arc shielded welding in a carbon dioxide gas atmosphere (“MAG welding”), and the two welding torches 85, 85 are connected in parallel to the welder main body 81 with a predetermined spacing therebetween. In this embodiment, as described above, eight sets of vertical guide structures 12 are provided, and two welding torches 85, 85 are mounted onto each of these vertical guide structures 12, and consequently overlay welding is performed with a total of 16 welding torches 85 being used concurrently.

Each of the welding units 20 is also equipped with the aforementioned wire supply device 21 that supplies wire to the two welding torches 85 belonging to that particular unit, and as described above, this wire supply device 21 is suspended from the suspended beam structure 9 via the aforementioned chain block 27 in a manner that enables the supply device to be raised and lowered. Furthermore, a hose 57 (see FIG. 8) for supplying the shield gas to the welding torches 85 is also connected to the welding torches 85 via the wire supply device 21.

As follows is a simple description of a method for conducting overlay welding on the inner wall surface 1d of the digester 1 using the welding units 20.

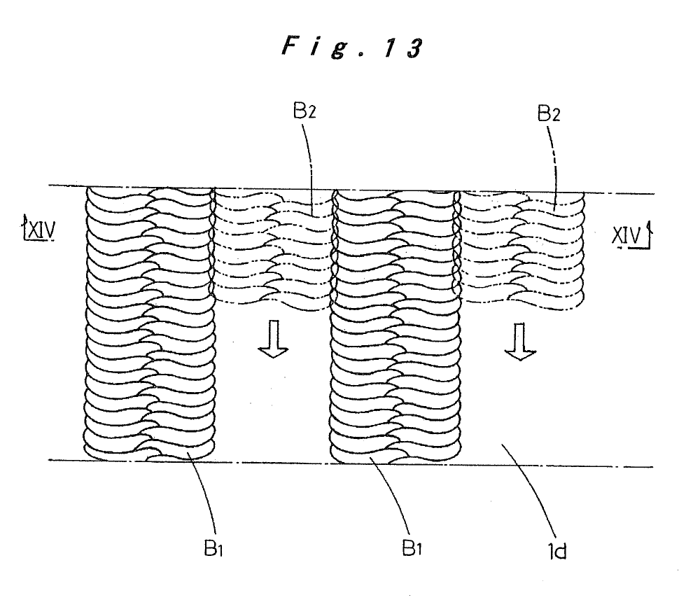

In this embodiment, the aforementioned welding units 20 are used to perform overlay welding on the inner wall surface 1d of the digester 1 by “vertical downward welding,” and the state of the weld beads in this type of overlay welding is shown in FIG. 13. In other words in this embodiment, using the aforementioned pair of welding torches 85, 85 that are arranged in parallel with a predetermined spacing therebetween, overlay welding is conducted by “vertical downward welding,” and consequently as shown by the solid lines in FIG. 13, weld beads B₁, B₁ from each of the welding torches 85, 85 are formed with a spacing that corresponds with the spacing between the welding torches. Then, after the welding units 20 have been moved from top to bottom, the arc is stopped temporarily. The welding units 20 are then raised once again, moved either left or right by an amount corresponding with the space between the welding torches 85, 85 (in other words, the aforementioned vertical guide structure 12 is moved left or right), and the next welding run is conducted in a downward direction, with the weld beads B₂, B₂ of this next run positioned between the weld beads B₁, B₁, from the previous run.

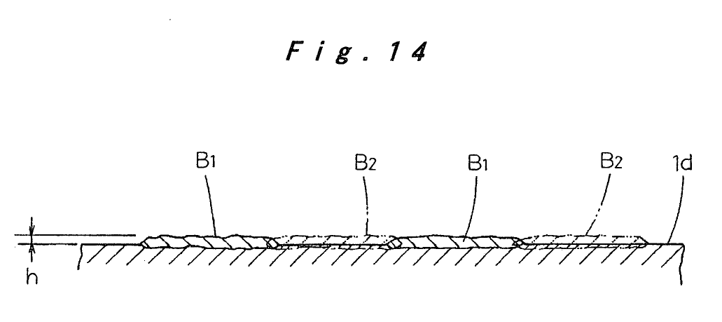

In this manner, by conducting the overlay welding sequentially with a predetermined pitch, an increase in the excess thickness of the side walls 1c of the digester 1 (see the dimension “h” in FIG. 14) is achieved for the overlaid sections. From FIG. 14 it is evident that the degree of weld penetration into the base metal (the inner wall surface 1d) during overlay welding is extremely small, and accordingly the heating effect on the base metal is also extremely limited, which means overlay welding provides an ideal method for increasing the wall thickness, although a large reason for this result is the fact that “downward welding” was used for the welding.

(B-8) Fixed Operations Platform 13

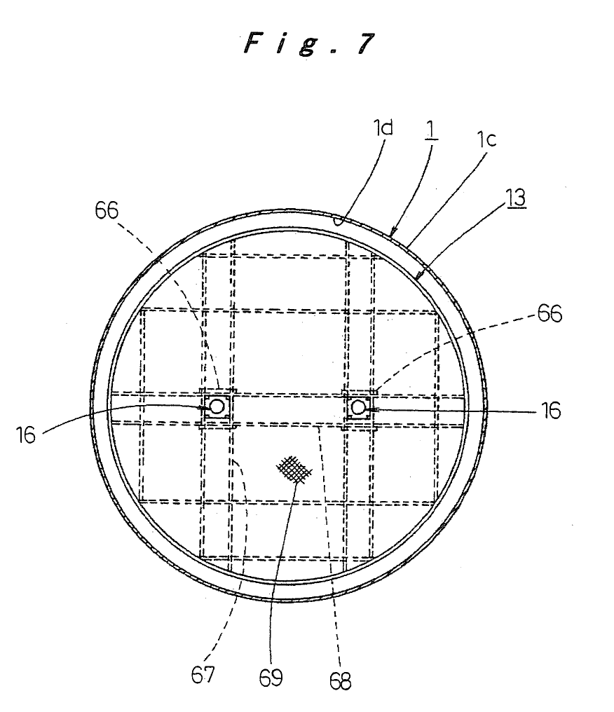

The fixed operations platform 13 described above is disposed in the vicinity of the guide mechanism Z (see the chain line in FIG. 8) and is used by an operator to control the state of the welding, and as shown in FIG. 7, is constructed by attaching a flooring material 69 to the top of a lattice of cleats 67, 68, thereby forming a circular shaped flat structure that follows the side wall 1c of the digester 1. A left and right pair of post retaining members 66, 66 are provided toward the center of the fixed operations platform 13, and the posts 16, 16 are positioned so as to pass through each of these post retaining members 66, 66. This fixed operations platform 13 is movable in up and down direction along the posts 16, 16, and can be secured to, and supported by, the posts 16, 16 at any arbitrary height by selectively mounting securing pins (not shown in the drawing) between the post retaining members 66, 66 and the corresponding posts 16, 16. During the operation for altering the installation height of this fixed operations platform 13, the height adjustable operations platform 14 described next is used.

Because the fixed operations platform 13 is carried into and out of the digester 1 through the aforementioned manhole 36, each of the structural elements must be able to be disassembled down to a size capable of passing through the manhole 36 (not shown in the drawings).

(B-9) Height Adjustable Operations Platform 14

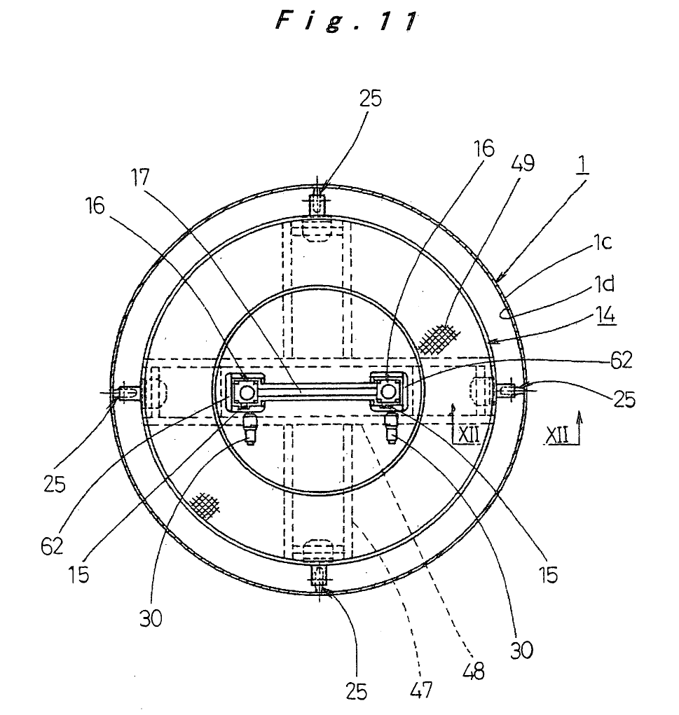

The height adjustable operations platform 14 described above is used for normal inspections, as well as for transporting materials to the fixed operations platform 13 or moving operators during the operations for conducting overlay welding on the inner wall surface 1d of the digester 1 with the aforementioned welding units 20, and as shown in FIG. 1 and FIG. 11, is formed as a circular shaped flat structure by attaching a flooring material 49 to the top of girder members 47, 48 that are assembled in a cross girder arrangement, with a predetermined spacing maintained between the periphery of the platform and the inner wall surface 1d of the digester 1.

This height adjustable operations platform 14 is equipped with a left and right pair of post guides 62, 62 provided in the central region of the platform, and the aforementioned posts 16, 16 pass through each of these post guides 62, 62. Travel drive motors 30, 30 are attached to one side of each of the post guides 62, 62, namely, on the side of the posts 16 to which the racks 15 are attached, and the pinion gears (not shown in the drawings) provided on the motors 30 engage with, and travel along the racks 15 on the side of the posts 16, enabling the height adjustable operations platform 14 to move up and down along the posts 16, 16 under its own power.

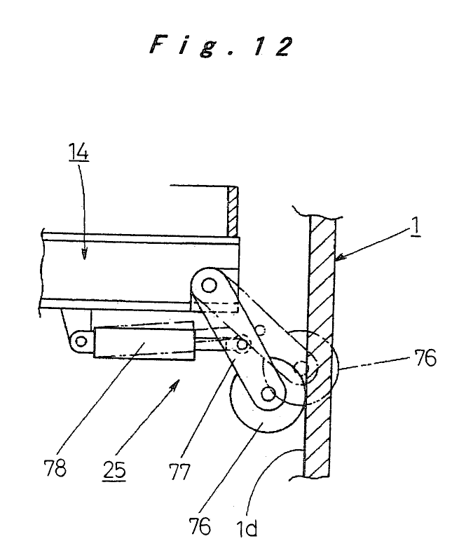

In addition, guide wheel units 25 are provided at four locations around the circumferential direction of the outer periphery of the height adjustable operations platform 14. These guide wheel units 25 run along the inner wall surface 1d of the digester 1 when the height adjustable operations platform 14 is raised or lowered, restricting sideways deviation of the height adjustable operations platform 14 and ensuring stable movement up and down. In other words, as shown in FIG. 12, the guide wheel units 25 are constructed by attaching a wheel 76 to the tip of a pivoted arm 77, which is provided on the height adjustable operations platform 14 and is free to swing in the radial direction of the digester 1, and then using a damper 78 to energize the arm 77 to apply pressure continually in the outward direction. According to such a construction, because the wheels 76 run along the inner wall surface 1d while being pressed against the inner wall surface with a constant, predetermined pressure, stability during the raising and lowering of the height adjustable operations platform 14 is ensured at all times, and because the wheels 76 are free to deviate along the radial direction of the digester 1, the wheels 76 accommodate steps in the inner wall surface 1d, and easily ride over such steps, meaning the reliability of the movement of the height adjustable operations platform 14 is ensured.

Because the height adjustable operations platform 14 is carried into and out of the digester 1 through the aforementioned manhole 36, each of the structural elements must be able to be disassembled down to a size capable of passing through the manhole 36 (not shown in the drawings).

C: Description of Operation of the Overlay Welding Operations Apparatus

As follows is a description of one example of the operating procedure for the operation of conducting overlay welding on the inner wall surface 1d of the aforementioned digester 1 using the aforementioned overlay welding operations apparatus.

For a welding operation, first, preparatory operations such as the assembling of operations platforms are carried out. In other words, first, the required materials are carried through the manhole 36 provided near the bottom section of the digester 1. Then, first the lower fixed operations floor 6 is assembled at the bottom section 1a of the digester 1, and the height adjustable operations platform 14 is then assembled on top of this lower fixed operations floor 6.

Next, the height adjustable operations platform 14 is moved up and down, while the aforementioned post pieces 16a, 16a, . . . are joined together sequentially in a stacked arrangement on top of the lower fixed operations floor 6, forming the posts 16, 16, and then the upper fixed operations floor 7 that is erected at the top section 1b of the digester 1 is secured to the top ends of the posts 16, 16. This completes the installation of the posts 16, 16.

Subsequently, assembling of the welding related equipment is conducted using the height adjustable operations platform 14, which moves up and down along the posts 16, 16. In other words, first the aforementioned suspension support base 8 is assembled and secured to the digester 1, and then the suspended beam structure 9 is assembled and suspended from the suspension support base 8 via the aforementioned chain blocks 18. In addition, the upper guide structure 10 is suspended from the suspended beam structure 9, each of the vertical guide structures 12, 12, . . . is attached to the upper guide structure 10, and the lower guide structure 11 is supported at the bottom end of each of these vertical guide structures 12, 12, . . . . In this state, both the upper guide structure 10 and the lower guide structure 11 are not secured to the inner wall surface 1d of the digester 1, and are movable freely in up and down direction.

The aforementioned fixed operations platform 13 is then assembled, mounted onto the height adjustable operations platform 14, raised to a predetermined height position by raising or lowering the height adjustable operations platform 14, and then secured to the posts 16, 16.

Meanwhile, cables 24 extending from a welding base unit 22 disposed outside the digester 1 are passed into the digester 1 through the bottom manhole 31 of the digester 1, and are fed through to the fixed operations platform 13, and of these cables 24, the power supply cable is connected to a welding controller 23 mounted on top of the fixed operations platform 13, and the carbon dioxide gas supply hose is connected to the welding units 20, 20, . . . attached to each of the vertical guide structures 12, 12, . . . .

This completes the preparatory operations required prior to the welding operations.

Subsequently, overlay welding using each of the welding units 20, 20, . . . is conducted on the inner wall surface 1d of the digester 1.

First, each of the chain blocks 18, 18, . . . are moved in synchronization with each other, and the suspended beam structure 9 is moved to a position immediately above the area targeted for welding. At this position, the upper guide structure 10 and the lower guide structure 11 are then secured to the inner wall surface 1d of the digester 1. In addition, with each of the vertical guide structures 12, 12, . . . in a state that enables relative movement with respect to the upper guide structure 10 and the lower guide structure 11 (in other words, a state in which both the check bolt 53 on the saddle 37, and the push bolt 73 on the vertical guide structure 12 are loosened), the position of each of the vertical guide structures 12, 12, . . . relative to the inner wall surface 1d, and the mutual spacing between each vertical guide structure 12, 12, . . . are adjusted. Subsequently, each of the vertical guide structures 12, 12, . . . is secured to the upper guide structure 10 and the lower guide structure 11. By securing these vertical guide structures 12, 12, . . . , the relative spacing in the left and right directions (that is, the circumferential direction of the vertical guide structures 12, 12, . . . ) between the welding units 20, 20, . . . attached to each of the vertical guide structures 12, 12, . . . , and the movement direction of each of the welding units 20, 20, . . . (that is, the direction of weld progression) can be set in a fixed manner.

In this state, each of the welding units 20, 20, . . . is positioned at the top end of its corresponding vertical guide structure 12, 12, . . . . Subsequently, power is supplied to each of the welding torches 85, 85 on each of the welding units 20, 20, . . . , and with the shield gas (carbon dioxide gas) also being supplied, each of the welding units 20, 20, . . . is moved concurrently downward at a predetermined speed, and overlay welding is conducted by the welding torches 85, 85 (see the solid line sections in FIG. 13). During this process, in this embodiment there are provided eight welding units 20, each of which is equipped with two welding torches 85, and consequently pairs of parallel weld beads B₁, B₁ that are produced with a spacing that corresponds with the spacing between the pair of welding torches 85, 85, are formed in eight locations around the inner wall surface 1d with a predetermined spacing therebetween, forming a total of 16 weld beads.

When the welding units 20, 20, . . . reach the bottom end of the vertical guide structures 12, 12, . . . , welding is temporarily halted, and the welding units 20, 20 . . . are raised, and placed in standby mode at the top end of the vertical guide structures 12, 12, . . . .

Next, the securing arrangement between the vertical guide structures 12, 12, . . . and the upper guide structure 10 and the lower guide structure 11 is released, each of the vertical guide structures 12, 12, . . . is moved in the left or right direction by a predetermined distance (that is, by a dimensional distance equivalent to the spacing of an aforementioned pair of welding torches 85, 85), and at this point the vertical guide structures 12, 12, . . . are once again secured to the upper guide structure 10 and the lower guide structure 11. In this state, each torch 85 of the welding units 20, 20 . . . is positioned between a pair of weld beads B₁, B₁, formed during the previous welding run.

In this state, each of the welding units 20, 20 . . . is reset to a welding capable state, and each of the welding units 20, 20, . . . is then moved downward at a predetermined speed, and a second overlay welding run is conducted by the welding torches 85, 85 (see the chain line sections in FIG. 13).

By repeating this welding operation a predetermined number of times, a predetermined region at a specific height on the inner wall surface 1d of the digester 1 would be overlaid around the entire inner circumference, enabling an increase in the thickness of the inner wall 1c.

Next, the level is adjusted to the next level requiring overlay welding. In other words, first, the securing arrangement of the upper guide structure 10 and the lower guide structure 11 relative to the inner wall surface 1d of the digester 1 is released, placing the guide structures in a free state. Subsequently, each of the chain blocks 18, 18, . . . is operated, and the suspended beam structure 9 is either raised or lowered by a predetermined distance (specifically, the distance in the height direction of the previous weld region). As the suspended beam structure 9 is moved, the upper guide structure 10, the lower guide structure 11, and the vertical guide structures 12, 12, . . . (namely, the aforementioned guide mechanism Z) are raised or lowered in concert, and the welding units 20, 20 . . . are positioned at the initial height for the next overlay welding operation. Subsequently, by executing the same sequence as the previous welding run, the next overlay welding operation is conducted either above or below the previous overlay welded region.

By conducting sequential overlay welding operations while repeating the type of left or right positional alteration of the welding units 20, 20 . . . , and the positional adjustment in the height direction of the guide mechanism Z described above, the required thickness repair operations is performed for all the sections of reduced thickness on the inner wall surface 1d. Following completion of thickness repair operations using overlay welding, the entire operation is completed by disassembling and carrying out each of the components, in the reverse order to that used during assembly.

Moreover, each of the exhaust systems 32 to 34 described above is operated continuously through the entire period from the commencement of preparatory operations through to the completion of welding operations, and this ensures good ventilation within the digester 1, and guarantees a safe operation performed in a good operating environment.

As described above, according to an overlay welding operations apparatus of this embodiment, the level adjustment accompanying the change of the welding position in the height direction is achieved solely by a suitable movement of the suspended beam structure 9 in either an up or down direction using the chain blocks 18, 18, . . . , and consequently compared with a conventional case in which a steel scaffold is put up inside the digester 1, and an operation for extending this scaffold must be conducted every time the welding height is altered, the operation for adjusting levels is markedly easier, the safety and operability of all operations throughout the entire welding operation, including the level adjustment operations, are improved, meaning the downtime for the digester 1 during the thickness repair operations is shortened.

In addition, in the embodiment described above, the welding units 20 are attached to the suspended beam structure 9 via the guide mechanism Z and are able to be moved up and down as well as left and right, and consequently the control of the operational status of the overlay welding conducted by the welding units 20, namely, control of factors such as the width of the weld bead, the weld direction, or the spacing between adjacent weld beads, is far simpler and more reliable than a case in which the above factors are entrusted entirely to the actions and judgment of an operator. As a result, overlay welding with as uniform a cladding as possible is formed over the entire region requiring overlay welding with a high level of reliability, resulting in an efficient extension of the life of the digester 1 by repairing the thickness of the wall.

Furthermore in this embodiment, the aforementioned posts 16, 16 are put up in a vertical direction inside the digester 1, the height adjustable operations platform 14 is attached to each of these posts 16, 16 and is movable in up and down direction under its own power, and consequently by using this height adjustable operations platform 14, operating materials and operators are moved safely and rapidly to the position of the welding units 20, without requiring any scaffold height adjustments, even if the digester 1 is a blast furnace type structure of considerable height, meaning both operational speed and safety are achieved.

In addition, in this embodiment, because the fixed operations platform 13 is attached to the posts 16 in a manner that enables the attachment height to be altered, during the welding operations an operator easily and accurately performs quality control checks of the welding produced by the welding units 20 from the fixed operations platform 13, meaning the reliability of the overlay welding is further improved.

D: Other Factors

In the embodiment described above, the digester 1 was described as one example of the “tower structure” that is the target of the present invention, but the “tower structure” is not restricted to structures such as the digester 1 with a blast furnace type construction, and for example, also includes comparatively low structures such as oil storage tanks and the like. In such cases, the posts 16 and the height adjustable operations platform 14 may not necessarily be required.

Furthermore, the aforementioned “tower structure” is not restricted to pressure vessels such as the aforementioned digester 1, and also includes structures used at comparatively low pressures.

In addition, in the above embodiment, the description focused on welding operations on the inner wall surface of the digester 1 as a representative example, but the operations apparatus for an inner wall surface and the operational method according to the present invention are not restricted to this example, and can also be ideally applied to a variety of other operations including inspection operations, modification operations, and cleaning operations. Furthermore, each of these different types of operations may be conducted individually, or a plurality of operations may be conducted conjointly, in parallel. In those cases in which inspection operations, modification operations, or cleaning operations are conducted, the aforementioned welding units 20 will be replaced, and an appropriate inspection device, modification operation device or cleaning device may be mounted to the guide mechanism Z.

Industrial Applicability

As described above, according to the present invention, by moving a suspended beam structure suspended below a suspension support base in an upward or downward direction, the height position within the aforementioned tower structure of an operations unit attached to the suspended beam structure, in other words, the height setting within the tower structure of the operational target region for the operations unit, is easily altered, and consequently compared with a conventional case where a scaffold is put up inside the tower structure, the height of the scaffold need not be changed every time the operating height is altered, and the operation for adjusting levels during operations is markedly easier, or even unnecessary, making the structure ideal for improving the safety and operability associated with all manner of operations.

1-6. (canceled)

7. An operations apparatus for an inner wall surface of a tower structure, wherein
a suspension support base is installed inside a tower structure, a suspended beam structure is suspended from said suspension support base in a manner that enables up and down movement, an operations unit is attached to said suspended beam structure via a guide mechanism in a manner that enables up and down and/or left and right movement, and operations are performed on an inner wall surface of said tower structure using said operations unit, and
said guide mechanism comprises an upper guide structure and a lower guide structure that are separated and oppose each other across a vertical direction, and a vertical guide structure, which extends between each of said guide structures and is disposed in a vertical direction, movable in a left and right direction along said guide structures, and supports said operations unit in a manner that enables up and down movement.

8. The operations apparatus for an inner wall surface of a tower structure according to claim 7, wherein said operations unit is equipped with at least welding, inspection, modification, and cleaning functions.

9. An operations apparatus for an inner wall surface of a tower structure, wherein
a suspension support base is installed inside a tower structure, a suspended beam structure is suspended from said suspension support base in a manner that enables up and down movement, an operations unit is attached to said suspended beam structure via a guide mechanism in a manner that enables up and down and/or left and right movement, and operations are performed on an inner wall surface of said tower structure using said operations unit, and
a post is put up in a vertical direction inside said tower structure; and a height adjustable operations platform being movable under its own power in the vertical direction along said post and a fixed operations platform being alterable its fixed vertical position relative to said post are installed.
